(19) United States
(12) Patent Application Publication
(10) Pub. No.: US 2024/0187674 A1
(43) Pub. Date: Jun. 6, 2024

(54) MASTER DEVICE, BROADCAST SYSTEM, AND METHOD FOR CONTROLLING MASTER DEVICE

(71) Applicant: NEC Corporation, Minato-ku, Tokyo (JP)

(72) Inventors: Yasubumi HONMA, Tokyo (JP); Kazuaki SAITO, Tokyo (JP); Fuyuki MATSUURA, Tokyo (JP); Nanami TANOUE, Tokyo (JP)

(73) Assignee: NEC Corporation, Minato-ku, Tokyo (JP)

(21) Appl. No.: 18/285,013

(22) PCT Filed: Apr. 8, 2021
(86) PCT No.: PCT/JP2021/014891

§ 371 Date: Sep. 29, 2023

(51) Int. Cl. H04N 21/2668; H04N 21/254

(52) U.S. Cl. CPC H04N 21/2668; H04N 21/254

(57) ABSTRACT

A master device of the present disclosure includes acquiring means, managing means, generating means, and transmitting means. The acquiring means acquires program organization data of a plurality of broadcast stations. The managing means manages the acquired program organization data for each of the broadcast stations. The generating means generates content for each of the broadcast stations using the managed program organization data. The transmitting means transmits the generated content to a terminal device that views a broadcast station corresponding to the content.

### TECHNICAL FIELD

The present invention relates to a master device, a broadcast system, a method for controlling the master device, and a non-transitory computer-readable medium.

### BACKGROUND ART

Operation of a broadcast station requires a large capital investment and operation cost. To date, broadcast stations have built and operated independent facilities with a large amount of investment. For example, if a building is not included, an investment of approximately several billion yen is required even in a small local station. It is not possible to easily enter even network simultaneous distribution because equipment for content production and transmission is required. Patent Literature 1 discloses a technique for transmitting a program content of a digital broadcast program including video/voice signal materials and content materials.

### CITATION LIST

### Patent Literature

Patent Literature 1: Japanese Unexamined Patent Application Publication No. 2009-267538

### SUMMARY OF INVENTION

### Technical Problem

However, Patent Document 1 has a problem in that a transmission master that transmits program content cannot be operated by a plurality of broadcast stations. In that case, for example, the transmission master cannot be efficiently operated because of introduction cost, operation cost, and the like of equipment.

In view of such a problem, an object of the present disclosure is to provide a master device, a broadcast system, a method of controlling the master device, and a non-transitory computer-readable medium that can be operated by a plurality of broadcast stations.

### Solution to Problem

A master device of the present disclosure includes: acquiring means for acquiring program organization data of a plurality of broadcast stations; managing means for managing the acquired program organization data for each of the broadcast stations; generating means for generating content for each of the broadcast stations using the managed program organization data; and transmitting means for transmitting the generated content to a terminal device that views a broadcast station corresponding to the content.

A broadcast system of the present disclosure includes a plurality of broadcast station systems of broadcast stations and a master device, the master device including: acquiring means for acquiring program organization data of the plurality of broadcast stations; managing means for managing the acquired program organization data for each of the broadcast stations; generating means for generating content for each of the broadcast stations using the managed program organization data; and transmitting means for transmitting the generated content to a terminal device that views a broadcast station corresponding to the content.

A method for controlling a master device according to the present disclosure includes: acquiring program organization data of a plurality of broadcast stations; managing the acquired program organization data for each of the broadcast stations; generating content for each of the broadcast stations using the managed program organization data; and transmitting the generated content to a terminal device that views a broadcast station corresponding to the content.

A non-transitory computer-readable medium of the present disclosure stores a program for causing a computer to execute processing for: acquiring program organization data of a plurality of broadcast stations; managing the acquired program organization data for each of the broadcast stations; generating content for each of the broadcast stations using the managed program organization data; and transmitting the generated content to a terminal device that views a broadcast station corresponding to the content.

### Advantageous Effects of Invention

According to the present disclosure, it is possible to provide a master device, a broadcast system, a method of controlling the master device, and a non-transitory computer-readable medium that can be operated by a plurality of broadcast stations.

### BRIEF DESCRIPTION OF DRAWINGS

FIG. 1 is a block diagram illustrating a configuration of a master device according to a first example embodiment.

FIG. 2 is a block diagram illustrating a configuration of a broadcast system according to a second example embodiment.

FIG. 3 is a schematic diagram illustrating processing of a broadcast station system according to the second example embodiment.

FIG. 4 is a schematic diagram illustrating an information management method of a master device according to the second example embodiment.

FIG. 5 is a flowchart illustrating an operation of the master device according to the second example embodiment.

FIG. 6 is a table illustrating an example of program organization data stored in the master device according to the second example embodiment.

FIG. 7 is a table illustrating an example of program organization data stored in the master device according to the second example embodiment.

FIG. 8 is a block diagram illustrating a configuration of a broadcast system according to a third example embodiment.

FIG. 9 is a flowchart illustrating an operation of a broadcast job management device according to the third example embodiment.

FIG. 10 is a table illustrating an example of a broadcast job flow stored in a broadcast job management device according to a third example embodiment.

FIG. 11 is a block diagram illustrating a configuration of a broadcast system according to a fourth example embodiment.

FIG. 12 is a block diagram illustrating a configuration of a computer according to an example embodiment.

### EXAMPLE EMBODIMENT

Example embodiments of the present disclosure are explained in detail below with reference to the drawings. In the drawings, the same or corresponding elements are denoted by the same reference numerals and signs and redundant explanation of the elements is omitted according to necessity for clarity of explanation.

“Content” indicates, for example, a video, a streaming moving image program with voice, or a VOD (Video On Demand) moving image program. In the present disclosure, “content” mainly refers to a streaming moving image program.

### First Example Embodiment

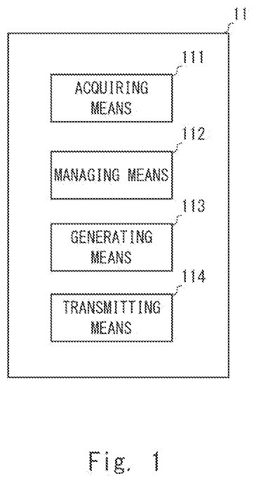

First, a configuration of a master device 11 according to a first example embodiment is explained with reference to FIG. 1.

The master device 11 includes acquiring means 111, managing means 112, generating means 113, and transmitting means 114. The acquiring means 111 acquires program organization data of a plurality of broadcast stations. The managing means 112 manages the acquired program organization data for each of the broadcast stations. The generating means 113 generates content for each of the broadcast stations using the managed program organization data. The transmitting means 114 transmits the generated content to a terminal device that views a broadcast station corresponding to the content.

The master device 11 according to the first example embodiment can execute management of program organization data and generation of content for each of the broadcast stations. Therefore, the master device 11 can be operated by the plurality of broadcast stations. For example, introduction cost and operation cost of equipment can be reduced. When the plurality of broadcast stations participate, a scale merit can be expected.

### Second Example Embodiment

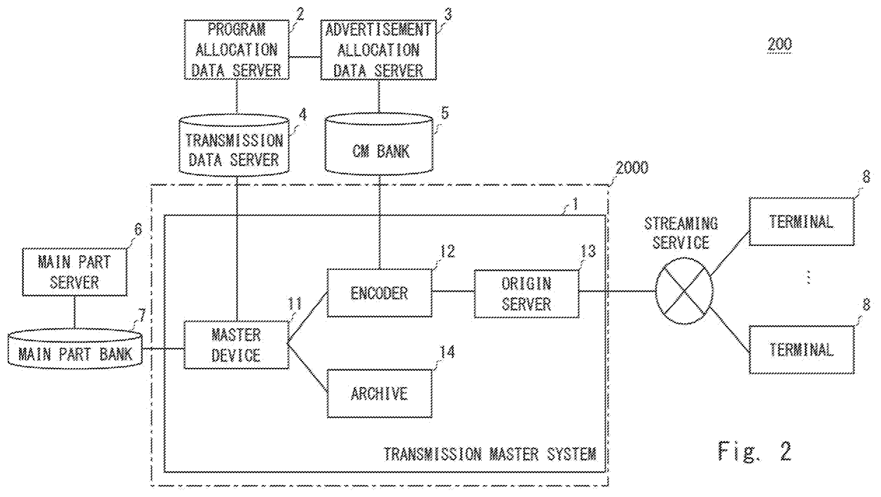

First, a configuration of a broadcast system 200 according to a second example embodiment is explained with reference to FIG. 2. The broadcast system 200 includes a transmission master system 1, a program allocation data server (a program allocation processing device) 2, an advertisement allocation data server (an advertisement allocation processing device) 3, a transmission data server 4, a CM bank (an advertisement accumulation device) 5, a main part server (a main part processing device) 6, a main part bank 7, and a terminal 8.

The transmission master system 1 includes a master device 11, an encoder 12, an origin server 13, and an archive 14 and is installed in a virtual space on the cloud.

The master device 11 includes acquiring means 111, managing means 112, generating means 113, and transmitting means 114.

The acquiring means 111 acquires program organization data of a broadcast station from the transmission data server 5. The program organization data is information indicating in which time period a program is organized and is, for example, a program guide indicating a schedule of a program to be broadcast.

In the program organization data, a program frame is present and an advertisement frame into which an advertisement is inserted is present between a program frame and a program frame int which programs are inserted. In the program frame, a main part frame into which a main part is inserted is present and an advertisement frame is present between a main part frame and a main part frame. The acquiring means 111 acquires a main part file from the main part bank 7. The acquiring means 111 acquires advertisement content from the CM bank 5.

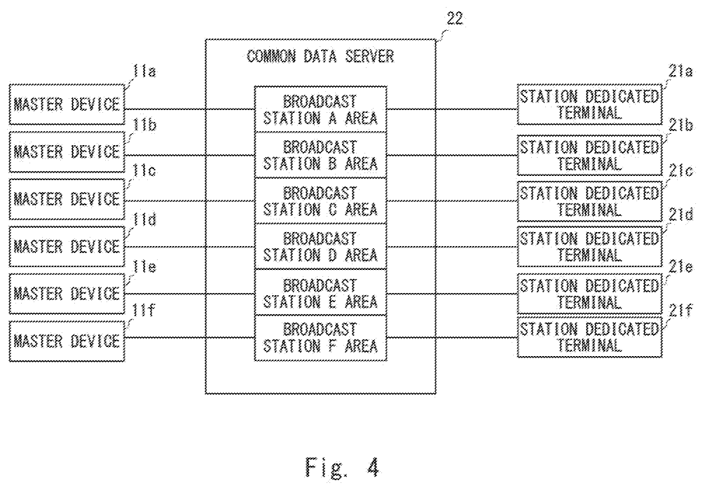

The managing means 112 manages the acquired program organization data for each of the broadcast stations. The managing means 112 allocates broadcast station identification information (hereinafter, a broadcast station ID (Identical Factor)) for identifying a broadcast station for each of the broadcast stations and manages the broadcast station ID and the program organization data in correlation with each other in a common data server 22 explained below with reference to FIG. 4. Note that the broadcast station ID is not limited to the broadcast station and may be an ID of an individual.

The generating means 113 generates content for each of the broadcast stations using the managed program organization data. Specifically, the generating means 113 generates, according to the program organization data, program content by combining the main part data acquired from the main part bank 7. The generating means 113 supplies the generated program content to the encoder 12.

The encoder 12 generates content to be transmitted to viewers using the advertisement content acquired from the CM bank 5 and the program content acquired from the master device 11. Specifically, encoder 12 inserts advertisement content corresponding to an advertisement frame included in the program content into the content. Then, the encoder 12 performs encoding such as a change of a data format and compression of the content and supplies the encoded content to the origin server 13.

The origin server 13 acquires the encoded content from the encoder 12. The origin server 13 transmits the content to terminals 8 of the viewers via a network such as the Internet. The origin server 13 transmits, for example, the content to the terminals 8 by streaming. The origin server 13 may store the acquired content.

The archive 14 stores content acquired from the master device 11. The stored content is used for, for example, a VOD service.

Note that the master device 11 may have functions of the encoder 12, the origin server 13, and the archive 14. For example, the acquiring means 111 may acquire advertisement content from the CM bank 5. The generating means 113 may generate content using the program organization data and the acquired advertisement content. Specifically, the generating means 113 may insert the advertisement content into the content based on advertisement identification information of the program organization data. The transmitting means 114 may acquire, from the terminal 8, viewing broadcast station information indicating a broadcast station to be viewed, supply content corresponding to the viewing broadcast station information to the encoder 12, and transmit the content to the terminals 8 by streaming.

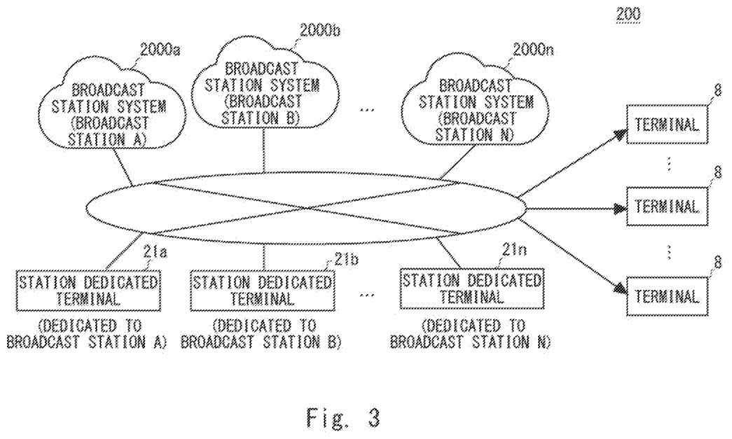

The transmission master system 1 is managed in a virtual space on the cloud. Therefore, the transmission master system 1 can be operated for each of the broadcast stations. In the present example embodiment, the broadcast system 200 manages, for each of the broadcast stations, a broadcast station system 2000 including the transmission master system 1. Specifically, the broadcast system 200 is explained with reference to FIG. 3 below. All the functions of the transmission master system 1 may operate on the cloud or a part of the functions may operate on the cloud and the remainder may operate on a physical server.

The program allocation data server 2 generates program organization data and supplies the program organization data to the transmission data server 4. Here, the program allocation data server 2 allocates a main part file explained below to the main part frame of the program organization data. That is, the program allocation data server 2 associates the main part frame of the program organization data with main part frame identification information for identifying the main part file explained below. The program allocation data server 2 uses the advertisement allocation information acquired from the advertisement allocation data server 3 and allocates advertisement content explained below to an advertisement frame of a program in the program organization data. That is, the program allocation data server 2 allocates the advertisement frame of the program of the program organization data and the advertisement identification information for identifying the advertisement content. A file including the main part frame and the advertisement frame obtained as a result is referred to as main part file.

The advertisement allocation data server 3 generates advertisement allocation information and supplies the advertisement allocation information to the CM bank 5. The advertisement allocation information is information indicating what kind of advertisement content is allocated to the advertisement frame of the program. The advertisement allocation data server 3 supplies the advertisement allocation information to the program allocation data server 2. The transmission data server 4 acquires program organization data from the program allocation data server 2 and stores the program organization data. Then, the transmission data server 4 supplies the program organization data to the transmission master system 1.

The CM bank 5 stores advertisement content and supplies the advertisement content to the transmission master system 1. The advertisement content indicates content of an advertisement that is inserted before and after the program or halfway in the program and distributed to the viewers.

The main part server 6 generates a main part file and supplies the main part file to the main part bank 7. The main part file is generated by, for example, moving image content produced by a broadcast station or an individual producer.

The main part bank 7 stores the main part file and supplies the stored main part file to the transmission master system 1.

The terminal 8 is a mobile terminal such as a smartphone or a tablet or a stationary terminal such as a TV or a PC (Personal Computer). The terminal 8 acquires content from the origin server 13 of the transmission master system 1 by streaming. For example, the terminal 8 includes a dedicated application and outputs a list of broadcast stations to which content can be distributed when the application is started and, when a broadcast station is selected by a user, acquires content corresponding to the broadcast station from the origin server 13 and outputs the content to a display.

Subsequently, processing of the broadcast station system 2000 according to the second example embodiment is explained with reference to FIG. 3.

As illustrated in FIG. 3, in the broadcast system 200, the transmission master system 1 is managed in a virtual space on the cloud, whereby the broadcast station system 2000 for transmitting content to the viewers is managed for each of the broadcast stations. Specifically, the broadcast system 200 manage broadcast station systems 2000 (a broadcast station system 2000a to a broadcast station system 2000n) for each of the broadcast stations (the broadcast station A to the broadcast station N). For example, when managing the broadcast station A, the broadcast station B, and the broadcast station N, the broadcast system 200 includes a broadcast station system 2000a corresponding to the broadcast station A, a broadcast station system 2000b corresponding to the broadcast station B, and a broadcast station system 2000n corresponding to broadcast station N. In broadcast system 200, the broadcast station system 2000 transmits, for each of the broadcast stations, content corresponding to the broadcast station to the terminal 8.

In the broadcast system 200, station dedicated terminals 21 (a station dedicated terminal 21a to a station dedicated terminal 21n) corresponding to the respective broadcast stations are used to control the broadcast station system 2000. For example, the station dedicated terminal 21a dedicated to the broadcast station A is used to control the broadcast station system 2000a. The station dedicated terminal 21b dedicated to the broadcast station B is used to control the broadcast station system 2000b. The station dedicated terminal 21n dedicated to the broadcast station N is used to control the broadcast station system 2000n. Here, an access for controlling the broadcast station system 2000 cannot be performed by terminals other than station dedicated terminal 21 corresponding to the broadcast station.

That is, in the broadcast system 200, the broadcast station system 2000 can execute transmission of different contents for each of the broadcast stations. In the broadcast system 200, the station dedicated terminal 21 can execute control of the broadcast station system 2000 for each of the broadcast stations.

Subsequently, an information management method for the master device 11 according to the second example embodiment is explained with reference to FIG. 4.

As illustrated in FIG. 4, the common data server 22 is a data server common to the broadcast stations and is installed in a virtual space on the cloud. The common data server 22 includes, for each of the broadcast stations (the broadcast station A to the broadcast station F), areas (a broadcast station A area to a broadcast station F area) in which data processing and data storage can be performed. The area is protected by security. The common data server 22 stores, for example, for each of the broadcast stations, program organization data in an area corresponding to the broadcast station.

The master device 11 corresponding to the broadcast station communicates with an area of the own broadcast station in the common data server 22. For example, the master device 11a corresponding to broadcast station A communicates with the broadcast station A area of common data server 22. The same applies to the master device 11b corresponding to the broadcast station B to the master device 11f corresponding to the broadcast station F. Here, the master device 11 acquires data such as program organization data from the area of the own broadcast station in the common data server 22.

The station dedicated terminals 21 (the station dedicated terminal 21a to the station dedicated terminal 21f) corresponding to the broadcast stations can access only the areas of the own broadcast stations of the common data server 22. That is, the station dedicated terminal 21 corresponding to the broadcast station can view or process data of the area of the own broadcast station of the common data server 22 but cannot view or process the data of the areas of the other broadcast stations. For example, the station dedicated terminal 21a corresponding to the broadcast station A can access the broadcast station A area of the common data server 22. The same applies to the station dedicated terminal 21b corresponding to the broadcast station B to the station dedicated terminal 21f corresponding to the broadcast station F.

In the common data server 22, in addition to specifications common to the broadcast stations, customization for the broadcast station unique specifications may be performed in the areas of the broadcast stations.

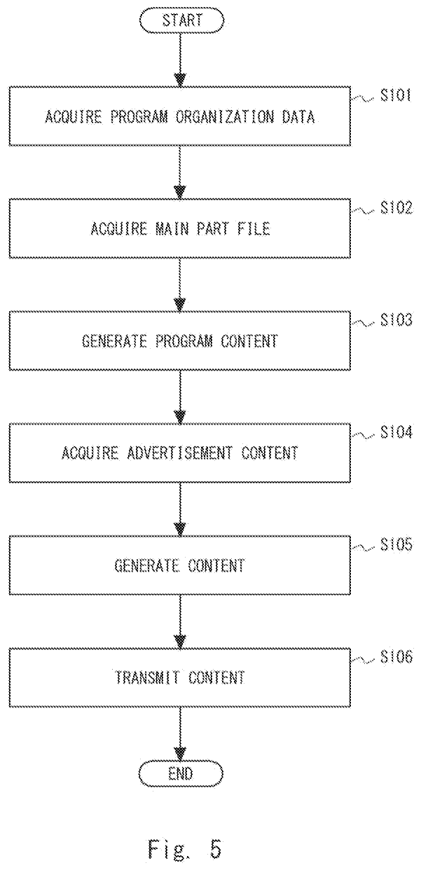

Subsequently, an operation of the broadcast system 200 according to the second example embodiment is explained with reference to FIG. 5.

First, the acquiring means 111 of the master device 11 acquires program organization data from the managing means 112 (step S101). Here, the acquiring means 111 specifies a broadcast station ID according to an acquisition source.

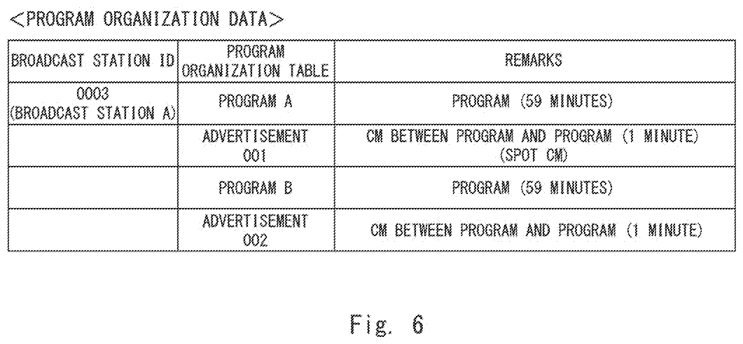

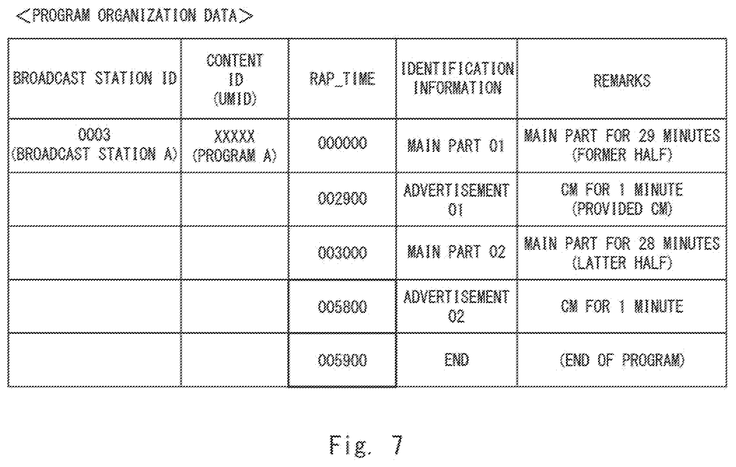

As illustrated in an example of FIG. 6 or FIG. 7, the managing means 112 allocates a broadcast station ID to each of the broadcast stations and manages the broadcast station ID and the program organization data in correlation with each other.

Subsequently, the acquiring means 111 acquires a main part file from the main part bank 7 (step S102). Note that the acquiring means 111 specifies the broadcast station ID according to the acquisition source. The managing means 112 may manage, for each of the broadcast stations, the main part file acquired from the main part bank 7 to be linked with the broadcast station ID. In this case, the acquiring means 111 may acquire the main part file from the managing means 112.

Subsequently, the generating means 113 generates program content using the program organization data and the main part file (step S103). Specifically, the generating means 113 combines the main part files according to main part identification information linked with a main part frame of the program organization data and generates the program content.

Subsequently, the acquiring means 111 acquires advertisement content from the CM bank 5 (step S104).

Subsequently, the generating means 113 generates content using the program content and the advertisement content (step S105). Specifically, in the program content, an advertisement frame linked with the advertisement identification information is present between a program and a program. In a program of the program content, the advertisement frame linked with the advertisement identification information is present between a main part and a main part. The generating means 113 generates content by inserting advertisement content corresponding to the advertisement identification information into the program content.

Subsequently, the transmitting means 114 transmits the generated content to the terminals 8 (step S106). Specifically, the transmitting means 114 acquires viewing broadcast station information indicating a broadcast station to be viewed from the terminal 8 and transmits content corresponding to the viewing broadcast station information to the terminal 8 by streaming.

Subsequently, an example of program organization data managed by the master device 11 according to the second example embodiment is explained with reference to FIG. 6.

As illustrated in FIG. 6, the managing means 112 of the master device 11 manages program organization data for each of the broadcast stations with, for example, a data table. The table includes an item of a broadcast station ID, an item of a program organization table, and an item of remarks. In the item of the broadcast station ID, identification information of the broadcast station is stored. In the item of the program organization table, program identification information of a program or advertisement identification information of a spot advertisement is stored. For example, in the item of the program organization table, program identification information of programs or advertisement identification information of spot advertisements are stored in order of transmission to viewers. In the item of the remarks, remark information of the program or the spot advertisement is stored. The remark information is information such as a playback time, a program name, and an advertisement name. In the data table, the item of the program organization table is linked with the item of the broadcast station ID and the item of the remarks is linked with the item of the program organization table.

An example illustrated in FIG. 6 indicates the following. The program organization data of the broadcast station A indicates that the program A for 59 minutes, a spot advertisement for 1 minute, the program B for 59 minutes, and a spot advertisement for 1 minute are sequentially transmitted.

Note that the broadcast station ID is unnecessary if the data management in the managing means 112 is independent for each of the broadcast stations.

Subsequently, an example of program organization data managed by the master device 11 according to the second example embodiment is explained with reference to FIG. 7. FIG. 7 is an example of an organization in the program A illustrated in FIG. 6.

As illustrated in FIG. 7, the managing means 112 of the master device 11 manages program organization data in, for example, a data table for each of the broadcast stations. The table includes an item of a broadcast station ID, an item of a content ID, an item of RAP_TIME, an item of identification information, and an item of remarks. In the item of the broadcast station ID, identification information of the broadcast station is stored. In the item of the content ID, program identification information of a program such as a UMID (Unique Material IDentifier) is stored. In the item of RAP_TIME, information indicating a playback start time of a material of content is stored. In the item of the identification information, main part identification information of a main part, which is the material of the content, or advertisement identification information of a provided advertisement is stored. In the item of the remarks, remark information of the material is stored. The remark information is information such as a playback time, a material name, and an advertisement name. Here, the item of the content ID is linked with the item of the broadcast station ID. The item of RAP_TIME, the item of the identification information, and the item of the remarks are linked with the item of the content ID.

An example illustrated in FIG. 6 indicates the following. In program A of the broadcast station A, a main part (a former half) of 29 minutes starts at 00 (hour) 00 (minute) 00 (second). A one minute advertisement (provided advertisement) starts at 00 (hour) 29 (minute) 00 (second). The main part (a latter half) of 28 minutes starts at 00 (hour) 30 (minute) 00 (second). A one minute advertisement starts at 00 (hour) 58 (minute) 00 (second). The program A ends at 00 (hour) 59 (minute) 00 (second).

Note that the broadcast station ID is unnecessary if the data management in the managing means 112 is independent for each of the broadcast stations.

The broadcast system 200 according to the second example embodiment can execute management of program organization data and the like and generation of content for each of the broadcast stations. Therefore, if the broadcast system 200 is conceptually arranged in parallel like the broadcast station system 2000, the broadcast system can be operated by a plurality of broadcast stations and, for example, introduction cost and operation cost of equipment can be reduced. When the plurality of broadcast stations participate, a scale merit can be expected.

The broadcast system 200 gives a broadcast station ID to the program organization data. Therefore, in the broadcast system 200, data is independent for each of the broadcast stations and the data can be easily managed.

The broadcast system 200 manages both of organization data of the entire program illustrated in FIG. 6 and organization data in the program illustrated in FIG. 7 in the program organization data. In the broadcast system 200, there is no distinction between a spot advertisement frame and a provided advertisement frame. The spot advertisement can be inserted into the provided advertisement frame.

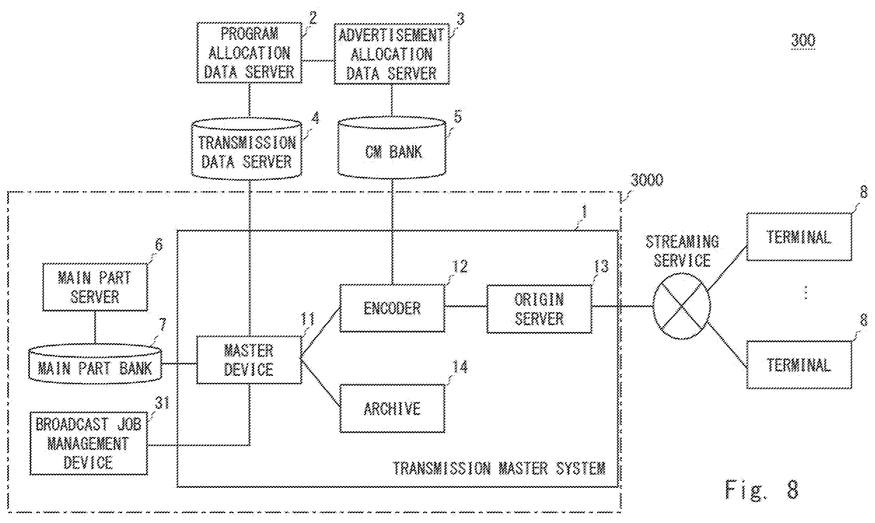

Subsequently, a configuration of a broadcast system 300 according to a third example embodiment is explained with reference to FIG. 8.

The broadcast system 300 includes the following configuration compared with the broadcast system 200 according to the second example embodiment. The broadcast system 300 further includes a broadcast job management device 31.

In the broadcast system 300, the main part server 6, the main part bank 7, and the broadcast job management device 31 are further managed in a virtual space on the cloud compared with the broadcast system 200. Here, the broadcast station system 3000 manages, for each of broadcast stations, a broadcast station system 30000 further including the main part server 6, the main part bank 7, and the broadcast job management device 31 in the broadcast station system 2000 illustrated in FIG. 3. The broadcast station system 30000 operates and manages, for each of the broadcast stations, a function of generating a main part file and a function of generating or transmitting content.

The broadcast job management device 31 manages a broadcast job flow for each of the broadcast stations. The broadcast job flow indicates a flow of processing of the broadcast station system 30000 and the master device 11. For example, the broadcast job flow manages progress information for each processing such as a generation status of content such as a program. Specifically, the broadcast job management device 31 generates the broadcast job flow according to program organization data. The broadcast job management device 31 manages the generated broadcast job flow for each of the broadcast stations. The broadcast job management device 31 controls processing of the broadcast station system 30000 and the master device 11 for each of the broadcast stations based on the progress information in the broadcast job flow.

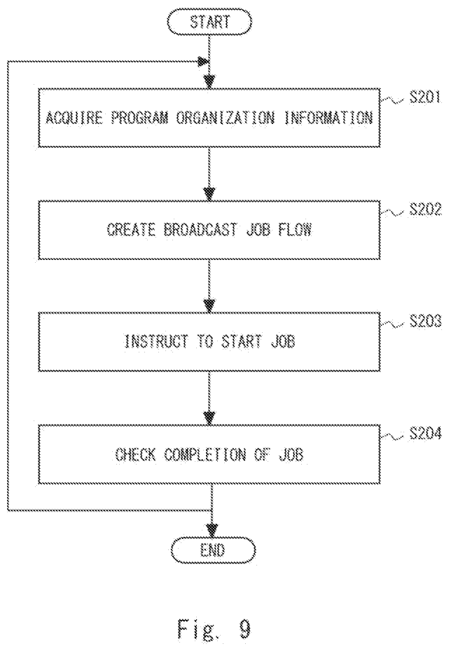

Subsequently, an operation of the broadcast system 300 according to the third example embodiment is explained with reference to FIG. 9.

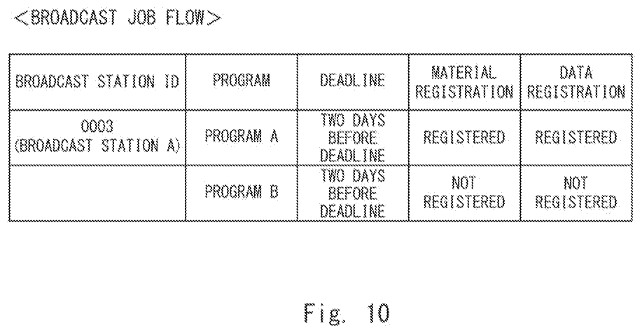

First, the broadcast job management device 31 acquires program organization data from the master device 11 (step S201). Subsequently, the broadcast job management device 31 generates a broadcast job flow according to the acquired program organization data (step S202). The information of the broadcast job flow is managed by a table illustrated in FIG. 10 explained below.

Subsequently, the broadcast job management device 31 instructs to start a job (step S203). Here, the broadcast job management device 31 controls the processing of the broadcast station system 30000 and the master device 11 for each of the broadcast stations according to the broadcast job flow. For example, when registration of content such as a program is not completed in the broadcast station A, the broadcast job management device 31 controls the master device 11 not to broadcast content including the content such as the program for which the registration is not completed in the broadcast station A. Then, after the job ends, the broadcast job management device 31 instructs a job end (step S204). After the processing of step S204, the broadcast job management device 31 may return to the processing in step S203 and, for example, update, change, or delete the broadcast job flow.

Subsequently, an example of a broadcast job flow stored in the broadcast job management device 31 according to the third example embodiment is explained with reference to FIG. 10.

The broadcast job management device 31 stores the broadcast job flow in, for example, a data table for each of the broadcast stations. Here, the broadcast job flow indicates progress information of generation processing for content such as a program in the broadcast station system. The table includes an item of a broadcast station ID, an item of a program, an item of a dead line, an item of material registration, and an item of data registration. In the item of the broadcast station ID, identification information of the broadcast station is stored. In the item of the program, identification information of a program is stored. In the item of the deadline, information concerning a deadline of delivery of the program is stored. In the item of the material registration, information (completed or not) as to whether a material of the program has been registered is stored. In the item of the data registration, information (completed or not) as to whether data of the material has been registered is stored.

The example illustrated in FIG. 10 indicates the following. In the broadcast job flow of the broadcast station A, a broadcast job flow of the program A and a broadcast job flow of the program B are managed. The broadcast job flow of the program A indicates that a delivery deadline in the program A is two days before, a material in the program A has been registered, and data of the material in the program A has been registered. The broadcast job flow of the program B indicates that a delivery deadline in the program B is two days before, a material of the program B has not been registered, and data of the material in the program B has not been registered. Note that the deadline of the delivery of the program in the broadcast job flow is not limited to two days and can be set.

In addition, when both of the material registration and the data registration have been completed, the broadcast job management device 31 may control the master device 11 to enable broadcast of the content.

The broadcast system 300 includes a cooperated management system 30 installed in a virtual space on the cloud. Therefore, by converting a management function for a broadcast job flow and the like, a function of generating a main part file, and a function of generating content into cloud, the broadcast system 300 can enable operation of the functions for each of the broadcast stations and more efficiently operate the functions.

The broadcast system 300 includes a broadcast job management device 31 and generates or manages a broadcast job flow. Therefore, the broadcast system 300 can collectively manage and implement a broadcast job flow from program generation to content transmission.

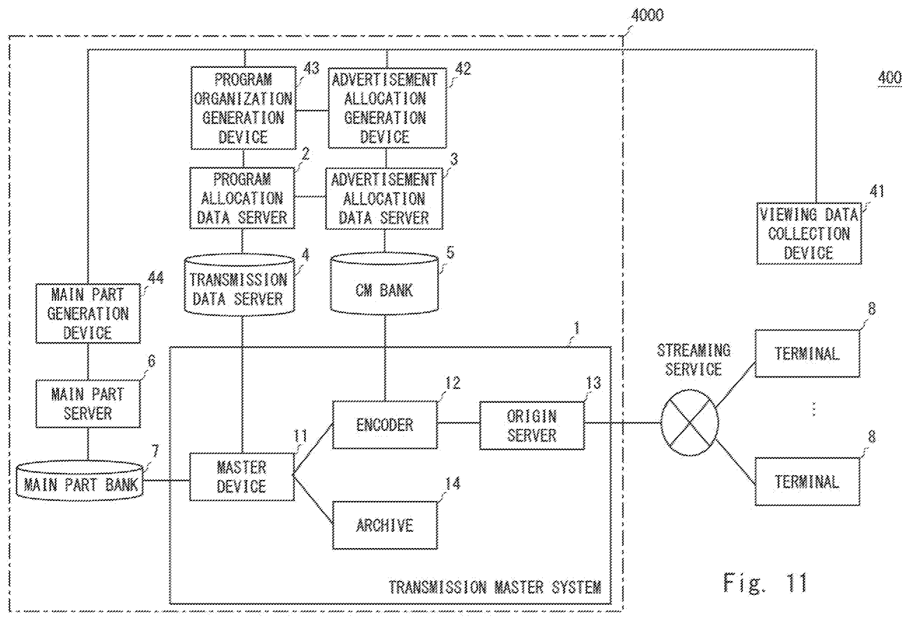

Subsequently, a configuration of a broadcast system 400 according to a fourth example embodiment is explained with reference to FIG. 11. Compared with the broadcast system 200 according to the second example embodiment, the broadcast system 400 further includes a viewing data collection device 41, an advertisement allocation generation device 42, a program organization generation device 43, and a main part generation device 44. In the broadcast system 400, compared with the broadcast system 200, the viewing data collection device 41, the advertisement allocation generation device 42, the program organization generation device 43, and the main part generation device 44 are further managed in a virtual space on the cloud. Here, the broadcast station system 4000 manages, for each of broadcast stations, the broadcast station system 40000 further including the main part server 6, the main part bank 7, the viewing data collection device 41, the advertisement allocation generation device 42, the program organization generation device 43, and the main part generation device 44 the broadcast station system 2000 illustrated in FIG. 3. The broadcast station system 40000 operates and manages, for each of the broadcast stations, a function of performing advertisement allocation, a function of generating program organization data, a function of generating a main part file, and a function of generating or transmitting content.

The viewing data collection device 41 collects viewing-related data of a viewer from the terminal 8. The viewing-related data is, for example, viewing history data or viewer attribute data. The viewing attribute data is attribute data such as gender, a birth year, and a residential place of the viewer. The viewing history data indicates a genre of content viewed by the viewer and history data in a viewing time of the content of the viewer. The viewing-related data is viewer action data relating to the viewing history data or the viewer attribute data. The viewer action data is data indicating an action such as a purchase action of the viewer.

The advertisement allocation generation device 42 acquires the viewing-related data from the viewing data collection device 41. The advertisement allocation generation device 42 analyzes a viewing tendency or preference of the viewer based on the viewing-related data and generates viewing analysis data, which is an analysis result. The advertisement allocation generation device 42 acquires advertisement allocation condition data, which is conditions for allocating an advertisement to a program, and advertisement content from a storing means. The advertisement allocation condition data is requirements of a sponsor such as a time of viewing the advertisement content, a genre of a program into which the advertisement content is inserted, or the advertisement content (a product name). The advertisement allocation generation device 42 automatically generates advertisement allocation information based on the viewing analysis data, the advertisement allocation condition data, and the advertisement content. Specifically, the advertisement allocation generation device 42 selects, based on the advertisement allocation condition data, advertisement candidates to be allocated and determines, based on the viewing-related data, an advertisement to be allocated from the selected advertisement candidates selected. For example, the advertisement allocation generation device 42 provides, to a viewer group that frequently accesses a program, an advertisement of a product for the viewer group and changes, according to a region having a strong influence of an advertisement provider, an advertisement of a product to be provided. Then, the advertisement allocation generation device 42 supplies the generated advertisement allocation information to the advertisement allocation data server 3 or the program organization generation device 43.

The program organization generation device 43 acquires the viewing-related data from the viewing data collection device 41. The program organization generation device 43 analyzes the viewing-related data and generates viewing analysis data indicating the viewing tendency or preference of the viewer. The program organization generation device 43 acquires, from the storing means, organization policy data indicating a policy of program organization of the broadcast station and program data. The program organization generation device 43 automatically generates program organization data based on the viewing analysis data, the organization policy data, the viewing analysis data, and the program data. Specifically, the program organization generation device 43 selects program candidates based on the organization policy data and determines, based on the viewing-related data, a program to be included in the program organization data from the selected program candidates. For example, the program organization generation device 43 generates program organization data in which a program accessed by a predetermined viewer group is organized in a time period when the viewer group frequently accesses and generates program organization data corresponding to the organization policy of the broadcast station. Then, the program organization generation device 43 supplies the generated program organization data to the program allocation data server 2. Note that program organization generation device 43 may reflect the advertisement allocation information generated by advertisement allocation generation device 42 on the program organization data. That is, the program organization generation device 43 may allocate the identification information of the advertisement to an advertisement frame included in the program organization data.

The main part generation device 44 acquires the viewing-related data from the viewing data collection device 41. The main part generation device 44 analyzes the viewing-related data and generates viewing analysis data indicating the viewing tendency or preference of the viewer. The main part generation device 44 acquires the main part generation condition data from the storing means. The main part generation condition data includes requirements of a program organization department of a broadcast station or the like, a genre of a main part program, or length of the main part program. The main part generation device 44 acquires a plurality of moving image contents from the storing means (not illustrated). The main part generation device 44 combines the moving image content based on the viewing analysis data and the main part generation condition data to automatically generate a main part file including the combined moving image content and to be transmitted to the viewer. Specifically, the main part generation device 44 selects, based on the main part generation condition data, candidates of the moving image content to be combined and determines, based on the viewing-related data, the moving image content to be combined from the selected candidates of the moving image content. For example, the main part generation device 44 generates moving image content matching the viewing tendency or preference of the viewer and generates moving image content corresponding to the requirements of the broadcast station and the main part producer. Then, the main part generation device 44 supplies the generated main part file to the main part server 6.

The master device 11 manages the generated program organization data or the generated main part file for each of the broadcast stations using a broadcast station ID or the like. The master device 11 generates content for each of the broadcast stations using the generated main part file and the generated program organization data. Then, the master device 11 generates content by inserting advertisement content into the content.

The broadcast system 400 according to the fourth example embodiment includes a cooperated management system 40 installed in a virtual space on the cloud. Therefore, by converting all functions of generating or transmitting content such as a function of performing advertisement allocation, a function of generating program organization data, and a function of generating a main part file into the cloud, the broadcast system 400 can enable operation for each of the broadcast stations and efficiently operate the functions.

In addition, the broadcast system 400 generates content using the advertisement allocation information, the program organization data, and the main part file generated using the analysis result of the information concerning the viewer of the content. Therefore, the broadcast system 400 can transmit content more effective for the viewer to the viewer. In addition, the broadcast system 400 generates content using the advertisement allocation information, the program organization data, and the main part file generated using the requirements of the sponsor and the broadcast station. Therefore, the broadcast system 400 can transmit content based on an intention of a transmission source of a broadcast such as the broadcast station to the viewer.

Note that the present invention is not limited to the example embodiments explained above and can be changed as appropriate without departing from the scope of the present invention.

For example, the broadcast system 400 may further include the broadcast job management device 31 according to the third example embodiment. In the broadcast system 400, the broadcast job management device 31 may be managed in a virtual space on the cloud. The broadcast station system 4000 may further include the broadcast job management device 31 in the broadcast station system 40000.

### Hardware Configuration

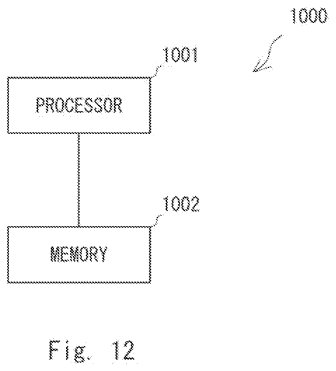

Subsequently, a hardware configuration example of a computer 1000 relating to devices (for example, the master device 11) configuring the master device 11, the broadcast system 200, the broadcast system 300, and the broadcast system 400 is explained with reference to FIG. 12. In FIG. 12, the computer 1000 includes a processor 1001 and a memory 1002. The processor 1001 may be, for example, a microprocessor, an MPU (Micro Processing Unit), or a CPU (Central Processing Unit). The processor 1001 may include a plurality of processors. The memory 1002 is configured by a combination of a volatile memory and a nonvolatile memory. The memory 1002 may include a storage disposed away from the processor 1001. In this case, the processor 1001 may access the memory 1002 via a not-illustrated I/O interface.

The devices in the example embodiments explained above may be configured by hardware, software, or both, may be configured by one piece of hardware or software, or may be configured by a plurality of pieces of hardware or software. The functions (the processing) of the devices in the example embodiments explained above may be realized by a computer. For example, programs for performing the methods in the example embodiments may be stored in the memory 1002 and the functions may be realized by the processor 1001 executing the programs stored in the memory 1002.

The programs explained above can be stored and supplied to the computer using various types of non-transitory computer-readable media. The non-transitory computer-readable media include various types of tangible storage media. Examples of non-transitory computer-readable medium include a magnetic recording medium (for example, a flexible disk, a magnetic tape, or a hard disk drive), a magneto-optical recording medium (for example, a magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (random Access memory)). The programs may be supplied to the computer through various types of transitory computer-readable media. Examples of the transitory computer-readable media include electrical signals, optical signals, and electromagnetic waves. The transitory computer-readable media can supply the programs to the computer via wired or wireless communication paths such as wires and optical fiber.

A part or all of the example embodiments explained above can be explained as in the following supplementary notes but are not limited to the following supplementary notes.

### (Supplementary Note 1)

A master device including:
acquiring means for acquiring program organization data of a plurality of broadcast stations;
managing means for managing the acquired program organization data for each of the broadcast stations; and
generating means for generating content for each of the broadcast stations using the managed program organization data; and
transmitting means for transmitting the generated content to a terminal device that views a broadcast station corresponding to the content.

### (Supplementary Note 2)

The master device described in Supplementary note 1, wherein the managing means allocates, to each of the broadcast stations, broadcast station identification information for identifying the broadcast station and manages the broadcast station identification information and the program organization data in correlation with each other.

### (Supplementary Note 3)

The master device described in Supplementary note 1 or 2, wherein
the acquiring means acquires program organization data of the plurality of broadcast stations, and
the managing means manages the acquired program organization data for each of the broadcast stations.

### (Supplementary Note 4)

The master device described in Supplementary note 3, wherein the generating means generates the content for each of programs included in the program organization data, using program organization data corresponding to the program.

### (Supplementary Note 5)

The master device described in any one of Supplementary notes 1 to 4, wherein
the acquiring means acquires advertisement content, and
the generating means generates the content, using the program organization data and the advertisement content.

### (Supplementary Note 6)

The master device described in Supplementary note 5, wherein
the program organization data includes advertisement identification information in a program, and
the generating means inserts the advertisement content into the content based on the advertisement identification information of the program organization data.

### (Supplementary Note 7)

The master device described in any one of Supplementary notes 1 to 6, wherein the transmitting means acquires viewing broadcast station information indicating the broadcast station to be viewed from the terminal device and transmits the content corresponding to the viewing broadcast station information to the terminal device.

### (Supplementary Note 8)

The master device described in any one of Supplementary notes 1 to 7, wherein the master device is disposed in a virtual environment on a cloud.

### (Supplementary Note 9)

A broadcast system including:
a plurality of broadcast station systems of broadcast stations; and
a master device,
the master device including:
acquiring means for acquiring program organization data of a plurality of broadcast stations;
managing means for managing the acquired program organization data for each of the broadcast stations;
generating means for generating content for each of the broadcast stations using the managed program organization data; and
transmitting means for transmitting the generated content to a terminal device that views a broadcast station corresponding to the content.

### (Supplementary Note 10)

The broadcast system described in Supplementary note 9, further including a broadcast job management device that manages a broadcast job flow indicating a flow of processing in the plurality of broadcast station systems and the master device.

### (Supplementary Note 11)

The broadcast system described in Supplementary note 10, wherein the broadcast job flow includes progress information for each kind of the processing.

### (Supplementary Note 12)

The broadcast system described in Supplementary note 11, wherein the broadcast job management device controls processing of the plurality of broadcast station systems and the master device based on the progress information.

### (Supplementary Note 13)

The broadcast system described in any one of Supplementary notes 10 to 12, wherein the broadcast job flow includes progress information of generation processing for the content in the plurality of broadcast station systems.

### (Supplementary Note 14)

The broadcast system described in Supplementary note 13, wherein the plurality of broadcast station systems includes a main part processing device that executes generation processing for moving image content included in the content.

### (Supplementary Note 15)

The broadcast system described in Supplementary note 14, wherein the master device and the main part processing device are arranged in a virtual environment on a cloud.

### (Supplementary Note 16)

The broadcast system described in any one of Supplementary notes 9 to 15, wherein the plurality of broadcast station systems include a program allocation processing device that generates the program organization data, an advertisement allocation processing device that allocates advertisement content to the program organization data, and an advertisement accumulation device that accumulates advertisement content to be inserted into the content.

### (Supplementary Note 17)

The broadcast system described in Supplementary note 16, wherein the program allocation processing device, the advertisement allocation processing device, and the advertisement accumulation device are arranged in a virtual environment on a cloud.

### (Supplementary Note 18)

The broadcast system described in any one of Supplementary notes 9 to 17, wherein the plurality of broadcast station systems include a program organization generation device that generates the program organization data based on information concerning a viewer, an advertisement allocation generation device that allocates advertisement content to the program organization data based on the information concerning the viewer, or a main part generation device that executes generation processing for moving image content included in the content based on the information concerning the viewer.

### (Supplementary Note 19)

The broadcast system described in Supplementary note 18, wherein the program organization generation device, the advertisement allocation generation device, and the main part generation device are arranged in a virtual environment on a cloud.

### (Supplementary Note 20)

A method of controlling a master device, the method comprising:
acquiring program organization data of a plurality of broadcast stations;
managing the acquired program organization data for each of the broadcast stations; and
generating content for each of the broadcast stations using the managed program organization data; and
transmitting the generated content to a terminal device that views a broadcast station corresponding to the content.

### (Supplementary Note 21)

A non-transitory computer-readable medium storing a program for causing a computer to execute processing for:
acquiring program organization data of a plurality of broadcast stations;
managing the acquired program organization data for each of the broadcast stations;
generating content for each of the broadcast stations using the managed program organization data; and
transmitting the generated content to a terminal device that views a broadcast station corresponding to the content.

### REFERENCE SIGNS LIST

1 TRANSMISSION MASTER SYSTEM
2 PROGRAM ALLOCATION DATA SERVER (PROGRAM ALLOCATION PROCESSING DEVICE)
3 ADVERTISEMENT ALLOCATION DATA SERVER (ADVERTISEMENT ALLOCATION PROCESSING DEVICE)
4 TRANSMISSION DATA SERVER
5 CM BANK (ADVERTISEMENT ACCUMULATION DEVICE)
6 MAIN PART SERVER (MAIN PART PROCESSING DEVICE)
7 MAIN PART BANK
8 TERMINAL
11 MASTER DEVICE
12 ENCODER
13 ORIGIN SERVER
14 ARCHIVE
21 STATION DEDICATED TERMINAL
22 COMMON DATA SERVER
31 BROADCAST JOB MANAGEMENT DEVICE
41 VIEWING DATA COLLECTION DEVICE
42 ADVERTISEMENT ALLOCATION GENERATION DEVICE
43 PROGRAM ORGANIZATION GENERATION DEVICE
44 MAIN PART GENERATION DEVICE
111 ACQUIRING MEANS
112 MANAGING MEANS
113 GENERATING MEANS
114 TRANSMITTING MEANS
200 BROADCAST SYSTEM
300 BROADCAST SYSTEM
400 BROADCAST SYSTEM
1000 COMPUTER
1001 PROCESSOR
1002 MEMORY
2000 BROADCAST STATION SYSTEM
3000 BROADCAST STATION SYSTEM
4000 BROADCAST STATION SYSTEM

What is claimed is:

1. A master device comprising:
at least one memory that is configured to store instructions; and
at least one processor that is configured to execute the instructions to:
acquire program organization data of a plurality of broadcast stations;
manage the acquired program organization data for each of the broadcast stations;
generate content for each of the broadcast stations using the managed program organization data; and
transmit the generated content to a terminal device that views a broadcast station corresponding to the content.

2. The master device according to claim 1, wherein the at least one processor that is configured to execute the instructions to allocate, to each of the broadcast stations, broadcast station identification information for identifying the broadcast station and manage the broadcast station identification information and the program organization data in correlation with each other.

3. The master device according to claim 1, wherein the at least one processor that is configured to execute the instructions to:
acquire program organization data of the plurality of broadcast stations; and
manage the acquired program organization data for each of the broadcast stations.

4. The master device according to claim 3, wherein the at least one processor that is configured to execute the instructions to generate the content for each of programs included in the program organization data, using moving image content corresponding to the program.

5. The master device according to claim 1, wherein the at least one processor that is configured to execute the instructions to:
acquire advertisement content; and
generate the content, using the program organization data and the advertisement content.

6. The master device according to claim 5, wherein
the program organization data includes advertisement identification information in a program, and
the at least one processor that is configured to execute the instructions to insert the advertisement content into the content based on the advertisement identification information of the program organization data.

7. The master device according to claim 1, wherein the at least one processor that is configured to execute the instructions to acquire viewing broadcast station information indicating the broadcast station to be viewed from the terminal device and transmit the content corresponding to the viewing broadcast station information to the terminal device.

8. The master device according to claim 1, wherein the master device is disposed in a virtual environment on a cloud.

9. A broadcast system comprising:
a plurality of broadcast station systems of broadcast stations; and
a master device,
the master device including:
at least one memory that is configured to store instructions; and
at least one processor that is configured to execute the instructions to:
acquire program organization data of a plurality of broadcast stations;
manage the acquired program organization data for each of the broadcast stations;
generate content for each of the broadcast stations using the managed program organization data; and
transmit the generated content to a terminal device that views a broadcast station corresponding to the content.

10. The broadcast system according to claim 9, further comprising a broadcast job management device that manages a broadcast job flow indicating a flow of processing in the plurality of broadcast station systems and the master device.

11. The broadcast system according to claim 10, wherein the broadcast job flow includes progress information for each kind of the processing.

12. The broadcast system according to claim 11, wherein the broadcast job management device controls processing of the plurality of broadcast station systems and the master device based on the progress information.

13. The broadcast system according to claim 10, wherein the broadcast job flow includes progress information of generation processing for the content in the plurality of broadcast station systems.

14. The broadcast system according to claim 13, wherein the plurality of broadcast station systems includes a main part processing device that executes generation processing for moving image content included in the content.

15. The broadcast system according to claim 14, wherein the master device and the main part processing device are arranged in a virtual environment on a cloud.

16. The broadcast system according to claim 9, wherein the plurality of broadcast station systems include a program allocation processing device that generates the program organization data, an advertisement allocation processing device that allocates advertisement content to the program organization data, and an advertisement accumulation device that accumulates advertisement content to be inserted into the content.

17. The broadcast system according to claim 16, wherein the program allocation processing device, the advertisement allocation processing device, and the advertisement accumulation device are arranged in a virtual environment on a cloud.

18. The broadcast system according to claim 9, wherein the plurality of broadcast station systems include a program organization generation device that generates the program organization data based on information concerning a viewer, an advertisement allocation generation device that allocates advertisement content to the program organization data based on the information concerning the viewer, or a main part generation device that executes generation processing for moving image content included in the content based on the information concerning the viewer.

19. The broadcast system according to claim 18, wherein the program organization generation device, the advertisement allocation generation device, and the main part generation device are arranged in a virtual environment on a cloud.

20. A method of controlling a master device, the method comprising:
acquiring program organization data of a plurality of broadcast stations;
managing the acquired program organization data for each of the broadcast stations; and
generating content for each of the broadcast stations using the managed program organization data; and
transmitting the generated content to a terminal device that views a broadcast station corresponding to the content.

21. (canceled)
